(19) United States
(12) Patent Application Publication
(10) Pub. No.: US 2012/0226369 A1
(43) Pub. Date: Sep. 6, 2012

(54) GAME DEVICE, SERVER DEVICE, GAME SYSTEM, GAME CONTROL METHOD, AND INFORMATION RECORDING MEDIUM STORING PROGRAM

(75) Inventor: Shoji MORI, Minato-ku (JP)

(73) Assignee: KONAMI DIGITAL ENTERTAINMENT CO., LTD., Tokyo (JP)

(21) Appl. No.: 13/371,182

(22) Filed: Feb. 10, 2012

(30) Foreign Application Priority Data
Mar. 1, 2011 (JP) 2011-043746

(51) Int. Cl. G06F 19/00

(52) U.S. Cl. 700/91

(57) ABSTRACT

The supervising part supervises information on fish objects in a virtual space. The control part moves, for example, a fish object on the hook. The display displays a position of a moving fish as a fish shadow. The calculation part calculates a catching area defined based on the position of the fish shadow and, the catching area being changed in shape and/or size according to a parameter of the fish object. The detection part detects indication operation indicating a position on the screen. The modification part increases/decreases the parameter of the fish object on the hook based on the positional relationship between the position of the indication operation and the calculated catching area while the indication operation is detected.

### CROSS-REFERENCE TO RELATED APPLICATION

This application claims the benefit of Japanese Patent Application No. 2011-043746, filed on Mar. 1, 2011, the entire disclosure of which is incorporated by reference herein.

### TECHNICAL FIELD

This application relates to a game device, server device, game system, game control method, and a non-transitory computer-readable information recording medium storing a program for giving the feeling of interaction in catching a virtual object through easier operation.

### BACKGROUND ART

In the prior art, various games (software) have been developed to be executed on commercial or home game devices. Among them, action games are constantly popular and favored by players of a wide range of ages.

Action games include games with which the player can virtually experience some existing sport or leisure activity.

For example, a fishing game with which the player can get the feeling of fishing is a game of catching a virtual fish (fish object). In other words, in such a game, the player catches a fish object or misses a fish object, getting the feeling of fishing.

As prior art techniques of such fishing games, some invented game devices (game systems) can be played by multiple players for more variations. Unexamined Japanese Patent Application Kokai Publication No. 2002-292131 (pp. 3-8, FIG. 1) discloses such game systems.

### SUMMARY

In the above prior art fishing game, generally, so-called bite (nibble) occurs under specific conditions, in which a fish object bites a bait (hook) and causes the tip of the fishing rod or the float to move. If the player moves the fishing rod properly without missing a bite, he/she can catch the fish object.

In other words, in the prior art fishing game, the player is supposed to conduct a specific operation (to move the fishing rod) at the time of a bite; the timing is crucial.

However, the fishing game in which the timing is crucial may not let the player feel the thrill of actual fishing.

For example, in actual bass fishing, some anglers feel a thrill in recovering (catching) a fish after he/she gets a bite and strikes (hooks) the fish. In other words, the player lets the fish swim in any direction as it wishes and waits for the fish being tired to a certain extent while trying not to allow the fish to be unhooked. Each time the fish slows down, the player reels in and gradually pulls in the fish under his/her hand. Such interaction is considered to be the thrill of fishing.

Therefore, there has been a demand for developing a game device allowing the player to experience the interaction with a virtual object.

The present invention is invented in view of the above circumstances and an exemplary object of the present invention is to provide a game device, server device, game system, game control method, and a non-transitory computer-readable information recording medium storing a program for giving the feeling of interaction in catching a virtual object through easier operation.

The game device according to a first exemplary aspect of the present invention is a game device of catching a virtual object, comprising a controller, display, calculator, detector, and modifier.

First, the controller moves an object (for example, a fish object on the hook) in a virtual space. The display displays the position of the moving object on a screen, for example, as a fish shadow. The calculator calculates a catching area defined based on the position of the displayed object (namely, the position of the fish shadow) and changing in shape and/or size according to a parameter (for example, physical strength, vitality, or capability) of the object. The detector detects indication operation indicating a position on the screen. Then, the modifier increases/decreases the parameter (namely, physical strength, etc.) of the object based on the positional relationship between the position of the indication operation and the calculated catching area while the indication operation is detected. For example, the modifier decreases the physical strength of the fish object on the hook when the player's finger is touching somewhere within the catching area moving along with the fish shadow, and increases the physical strength of the fish object when the player's finger is touching nowhere within the catching area.

In the above game device, the detector may detect touch operation of the player via a touch panel superimposed on the screen.

Then, in order to catch a fish object on the hook, the player keeps moving a finger or the like through touch operation in accordance with the move of the fish object (fish shadow). Consequently, the player can get the feeling of interaction in catching a virtual object through easier operation.

The above game device may further comprise a supervisor supervising a parameter (for example, physical strength, vitality, or capability) of the object for which at least a different initial value is set according to the type of the object (for example, the fish object on the hook), wherein the modifier controls the supervisor to decrease the parameter (namely, physical strength, etc.) when the position of the detected touch operation is within the catching area, and controls the supervisor to increase the parameter when the position of the touch operation is outside the catching area.

In such a case, the physical strength of the fish object on the hook is increased/decreased depending on whether the player conducts the follow operation properly, altering the catching result: successful or unsuccessful.

It is possible that the supervisor further supervises the virtual distance between the object and player; and the modifier controls the supervisor to increase/decrease the distance based on the direction of successive moves when the position of touch operation detected by the detector is successively moved. For example, if the player moves his/her finger in the vertical direction in touch operation, a virtual reel-in operation is conducted to decrease the distance between the fish object on the hook and the player.

The above game device may further comprise a determiner determining whether the object (for example, a fish object on the hook) is caught based on a parameter (for example, physical strength, vitality, or capability) and the distance that are supervised by the supervisor. For example, when both a parameter (namely, physical strength, etc.) and the distance supervised are lower than reference values, it is determined that the exhausted fish object is pulled in close to the player and the fish object is caught (recovered).

The game control method according to a second exemplary aspect of the present invention is a game control method executed by a game device of caching a virtual object that has a controller, display, calculator, detector, and modifier, comprising control, display, calculation, detection, and modification steps.

First, in the control step, an object (for example, a fish object on the hook) is moved in a virtual space. In the display step, the position of the moving object is displayed on a screen of the terminal, for example, as a fish shadow. In the calculation step, a catching area defined based on the position of the displayed object (namely, the position of the fish shadow) and changing in shape and/or size according to a parameter (for example, physical strength, vitality, or capability) of the object is calculated. In the detection step, indication operation indicating a position on the screen is detected. Then, in the modification step, the parameter (namely, physical strength, etc.) of the object is increased/decreased based on the positional relationship between the position of indication operation and the calculated catching area while the indication operation is detected. For example, the physical strength of the fish object on the hook is decreased when the player's finger is touching somewhere within the catching area moving along with the fish shadow, and the physical strength of the fish object is increased when the player's finger is touching nowhere within the catching area.

Then, in order to catch a fish object on the hook, the player keeps moving a finger or the like through touch operation in accordance with the move of the fish object (fish shadow). Consequently, the player can get the feeling of interaction in catching a virtual object through easier operation.

A non-transitory computer-readable information recording medium storing a program according to a third exemplary aspect of the present invention allows a computer (including an electronic device) of catching a virtual object to function as the above game device.

The programs can be recorded on a non-transitory computer-readable information recording medium such as a compact disc, flexible disc, hard disc, magneto optical disc, digital video disc, magnetic tape, and semiconductor memory.

The above programs can be distributed/sold separately from a computer executing the programs via a computer communication network. Furthermore, the above information recording medium can be distributed/sold separately from the computer.

The present invention can give the feeling of interaction in catching a virtual object through easier operation.

### BRIEF DESCRIPTION OF THE DRAWINGS

A more complete understanding of this application can be obtained when the following detailed description is considered in conjunction with the following drawings, in which:

FIG. 1 is a schematic illustration showing the appearance of an information processing device according to the embodiment;

FIG. 2 is a block diagram showing the general configuration of the information processing device according to the embodiment;

FIG. 3 is a block diagram for explaining the configuration of the game device according to the embodiment;

FIG. 4 is a chart for explaining various pieces of information supervised by the supervising part;

FIG. 5 is a schematic illustration for explaining an exemplary game image;

FIG. 6A is a schematic illustration for explaining how a finger follows the move of a fish shadow;

FIG. 6B is a schematic illustration for explaining the finger moving in the vertical direction;

FIG. 7A is a schematic illustration for explaining a catching area;

FIG. 7B is another schematic illustration for explaining a catching area;

FIG. 7C is another schematic illustration for explaining a catching area;

FIG. 8A is a schematic illustration for explaining the relationship between the catching area and a finger position;

FIG. 8B is another schematic illustration for explaining the relationship between the catching area and a finger position;

FIG. 9A is a schematic illustration for explaining the virtual reel-in operation;

FIG. 9B is another schematic illustration for explaining the virtual reel-out operation;

FIG. 10 is a flowchart for explaining the game control procedure according to the embodiment;

FIG. 11A is a schematic illustration showing an exemplary image announcing a successful catch; and

FIG. 11B is a schematic illustration showing an exemplary image announcing an unsuccessful catch.

### DETAILED DESCRIPTION

An embodiment of the present invention will be described hereafter. For easier understanding, an embodiment to apply the present invention to a portable game machine (game device) will de described hereafter. However, the present invention is similarly applicable to various information processing devices including computers, PDAs, and cell-phones. In other words, the following embodiment is given for explaining the present invention and does not confine the scope of the invention of the present application. Therefore, a person of ordinary skill in the field may embrace an embodiment in which some or all components are replaced with equivalent components. Such an embodiment falls under the scope of the resent invention.

### Embodiment

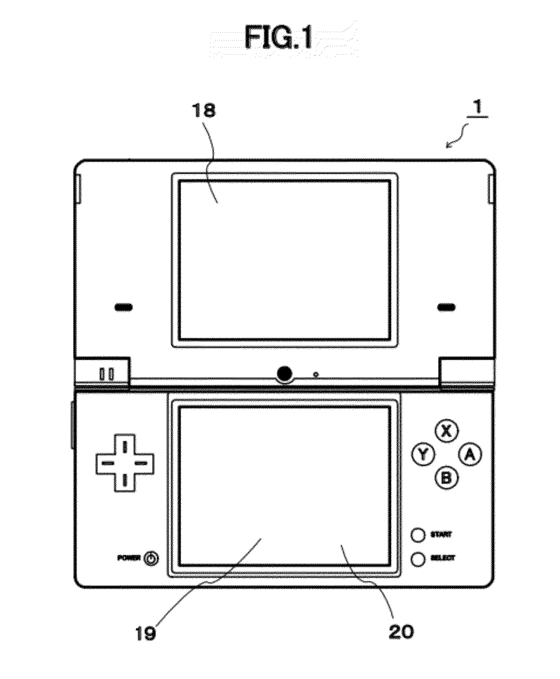

FIG. 1 is a schematic illustration showing the general structure of a typical information processing device on which the game device according to an embodiment of the present invention is realized. An information processing device 1 is a portable game machine by way of example. This portable game machine has, as shown in the figure, a first display part 18 and a second display part 19, on each of which given images can be displayed. Here, a touch panel 20 is superimposed on the second display panel 19.

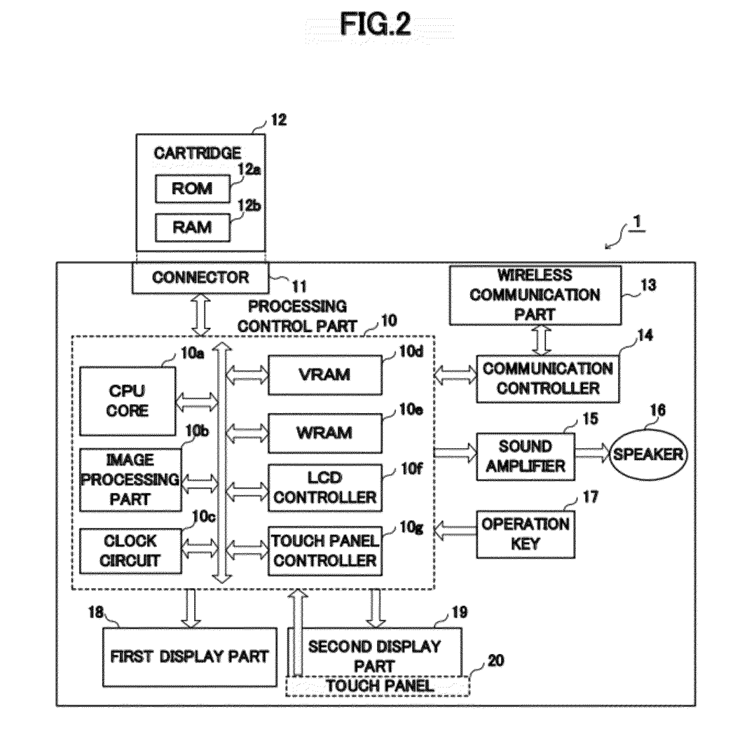

FIG. 2 is a diagram showing the general configuration of the information processing device 1. The information processing device 1 will be described hereafter with reference to this figure.

The information processing device 1 comprises a processing control part 10, a connector 11, a cartridge 12, a wireless communication part 13, a communication controller 14, a sound amplifier 15, a speaker 16, an operation key 17, a first display part 18, a second display part 19, and a touch panel 20.

The processing control part 10 comprises a CPU (central processing unit) core 10a, an image processing part 10b, a clock circuit 10c, a VRAM (video random access memory) 10d, a WRAM (work RAM) 10e, an LCD (liquid crystal memory) controller 10f, and a touch panel controller 10g.

The CPU core 10a controls the entire operation of the information processing device 1, is connected to the components, and exchanges control signals and data between the components. More specifically, with the cartridge 12 being mounted on the connector 11, the CPU core 10a reads programs and data stored in a ROM (read only memory) 12a within the cartridge 12 and executes given processing.

The image processing part 10b processes data read from the ROM 12a within the cartridge 12 and data processed by the CPU core 10a and stores them in the VRAM 10d.

The clock circuit 10c is a circuit to present various periods of time (points of time), providing the current time set in the game device 1 and elapsed times necessary in the course of a game.

The VRAM 10d is a memory to store display information, storing image information processed by the image processing part 10b and the like.

The WRAM 10e stores work data necessary for the CPU core 10a to execute various procedures according to programs.

The LCD controller 10f controls the first and second display parts 18 and 19 to display given display images. For example, the LCD controller 10f converts image information stored in the VRAM 10d to display signals at given synchronized times to display images on the first display parts 18. Similarly, the LCD controller 10f displays images on the second display part 19.

When the touch panel 20 is pressed by the player with a touch pen or finger, the touch panel controller 10g acquires the coordinates (input coordinates).

The connector 11 is a terminal to which the cartridge 12 is detachably connected. When the cartridge 12 is connected, the connector 11 exchanges given data with the cartridge 12.

The cartridge 12 comprises a ROM 12a and a RAM (random access memory) 12b.

Programs for realizing games and image data and sound data accompanying the games are recorded in the ROM 12a. Various data indicating the progress of a game are stored in the RAM 12b.

The wireless communication part 13 is a unit conducting wireless communication with the wireless communication part 13 of another information processing device 1 and exchanges given data via a not-shown antenna (built-in antenna).

The wireless communication part 13 can conduct wireless communication with a given wireless access point. Furthermore, the wireless communication part 13 is given a unique MAC (media access control) address.

The communication controller 14 controls the wireless communication part 13 and mediates wireless communication between the processing control part 10 and the processing control part 10 of another information processing device 1 according to a given protocol.

Furthermore, when the information processing device 1 makes connection to the Internet via a nearby wireless access point, the communication controller 14 mediates wireless communication between the processing control part 10 and the wireless access point according to a wireless LAN-compliant protocol.

The sound amplifier 15 amplifies sound signals generated by the processing control part 10 and supplies them to the speaker 16.

The speaker 16 consists of, for example, a stereo speaker and outputs given music sound and sound effects according to the sound signals amplified by the sound amplifier 15.

The operation key 17 consists of multiple key switches properly arranged on the information processing device 1 or the like and receives input of given instruction according to user operation.

The first and second display parts 18 and 19 consist of an LCD or the like. Controlled by the LCD controller 10f, the first and second display parts 18 and 19 properly display game images and the like.

Here, the second display part 19 displays a given target image (an enemy object and the like) that is the target of input (pressing down) to the touch panel 20.

The touch panel 20 is superimposed on the second display part 19 and detects input from the player with a touch pen or a finger.

For example, the touch panel 20 consists of a resistive touch sensor panel, detecting a pressure (pressing down) by a touch pen or a finger of the player and outputting information (signals) corresponding to the coordinates thereof.

Outline of the Game Device

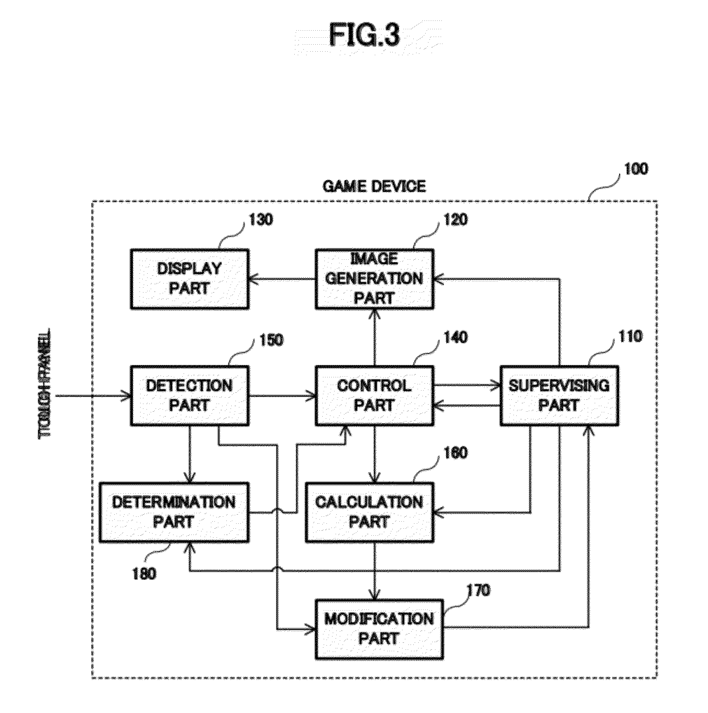

FIG. 3 is a block diagram showing the general configuration of a game device 100 as described above. The game device 100 provides a fishing game of catching a virtual fish object through touch panel operation. More specifically, the player moves his/her finger or the like in contact with the touch panel in accordance with the move of a fish object on the hook (hooked). Through this operation, the player lets the fish object swim and be exhausted (reducing the physical strength) while trying not to put a too much load on the fishing line. Then, as soon as the fish object on the hook stops moving (weakens), the player conducts a specific operation to reel in with the virtual reel so as to reduce the distance to the fish object and catch the fish object. The game device 100 will be described hereafter with reference to the figure.

The game device 100 comprises a supervising part 110, an image generation part 120, a display part 130, a control part 140, a detection part 150, a calculation part 160, a modification part 170, and a determination part 180.

The supervising part 110 supervises information on fish objects that are possible prizes in a virtual space.

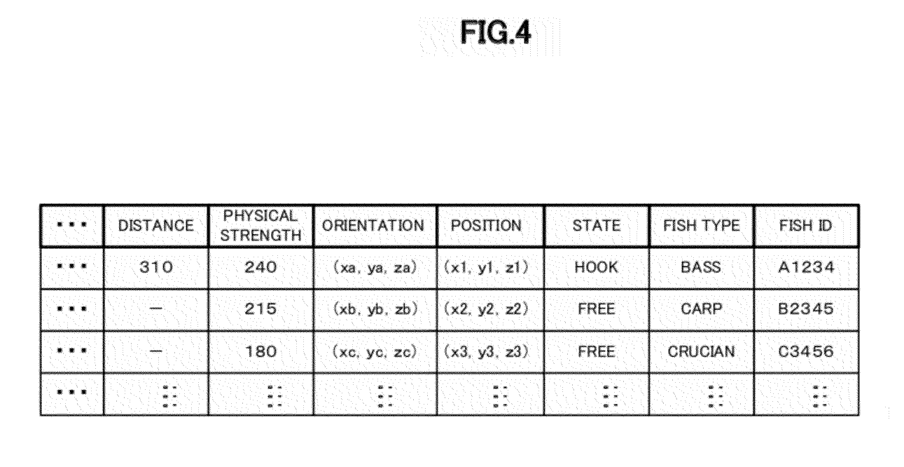

The supervising part 110 supervises the fish objects based on information including fish ID, type, state, position, orientation, physical strength, and distance as shown in FIG. 4.

The field “state” in the figure presents the current state of a fish object. A fish object having a word “hook” in this field is a fish object on the hook (hooked).

The field “physical strength” in the figure presents the current physical strength of a fish object. The physical strength is set to a different initial value, for example, depending on the type of the fish object, and properly increased/decreased based on the player's operation (a follow operation described later) after the strike. Here, the physical strength is an exemplary parameter of a fish object and other traits can be supervised. For example, vitality or capability, or freshness indicating liveliness can be supervised as appropriate.

The field “distance” in the figure presents the distance between the fish object on the hook and the player. More specifically, the distance presents the length of the virtual fishing line extended from the virtual reel (the length of the fishing line between the reel and hook). The distance is properly increased/decreased based on the player's operation (reel-in operation or reel-out operation described later).

In addition, the supervising part 110 supervises information necessary for a game (for example, information on the fishing rod, fishing line, bait/lure, etc.) and the time limit and accumulated time described later. The above-described WRAM 10e and the like can function as the above supervising part 110.

Returning to FIG. 3, the image generation part 120 generates game images under the control of the control part 140.

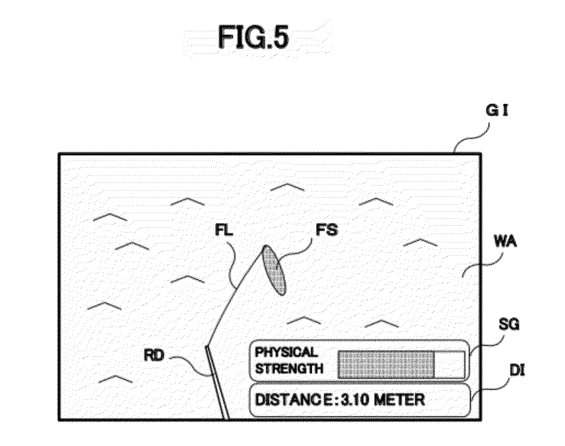

For example, the image generation part 120 generates a game image GI as shown in FIG. 5. The game image GI is an exemplary planar image of a fishing site (virtual fishing site) such as a lake and river seen from above, including a fish shadow FS on the water surface WA, a fishing rod RD, a fishing line FL, a physical strength gauge SG, and a distance indicator DI. The fish shadow FS is an image indicating the approximate position of the fish object on the hook and moves on the water surface WA as the fish object migrates in the water. Furthermore, the fishing rod RD and fishing line FL also moves properly (changes in direction) as the fish shadow FS moves. In other words, game image GIs in which the fish object on the hook irregularly swims in the water as described above and the fish shadow irregularly moves accordingly are generated.

The physical strength gauge SG is a gauge indicating the physical strength of the fish object on the hook. The distance indicator DI indicates the length of the fishing line FL extended from the virtual reel to the fish object.

The above-described image processing part 10b and the like can function as the above image generation part 120.

The display part 130 displays game images generated by the image generation part 120. The above-described touch panel 20 is superimposed on the display part 130.

Then, the player can conduct desired touch operation via the touch panel 20 (for example, a follow operation of moving a finger so as to follow the move of the fish shadow SF) while the display part 130 displays a game image GI in which the fish shadow irregularly migrates such as the above-described FIG. 5.

The above-described second display part 19 and the like can function as the above display part 130.

The control part 140 controls the entire game device 100.

For example, the control part 140 properly moves fish objects in a virtual space. In other words, the control part 140 properly updates the position and orientation supervised by the supervising part 110 according to a given logic so that the fish objects migrate in the water. Particularly, update is made for the fish object on the hook to irregularly migrate. More specifically, the control part 140 updates the position and orientation so that the fish objects successively migrate at a speed (displacement) according to the physical strength with random directional change in every given time period (for example, 0.5 second). Furthermore, each time the physical strength of the fish object on the hook is decreased by a given quantity (for example, 50), the fish object rests (or migrates very little) for a given time period (for example, one second), indicating that the fish object is exhausted.

According to the above fish object migration control, the above-described image generation part 120 moves the fish shadow FS irregularly in the above-described game image GI in FIG. 5.

The above-described CPU core 10a and WRAM 10e can function as the above control part 140.

The detection part 150 detects the contact position of the player's finger or the like based on information (signals indicating the position) obtained from the touch panel 20. In other words, the detection part 150 detects the position in response to touch operation to touch the touch panel 20.

For example, the detection part 150 can detect the positions until the player removes his/her finger or the like from the touch panel 20 since he/she has touched the touch panel 20. Therefore, even if the player moves his/her finger or the like (moves the finger while keeping it in contact), or even if the player holds the finger, the detection part 150 can successively detect the position (current contact position).

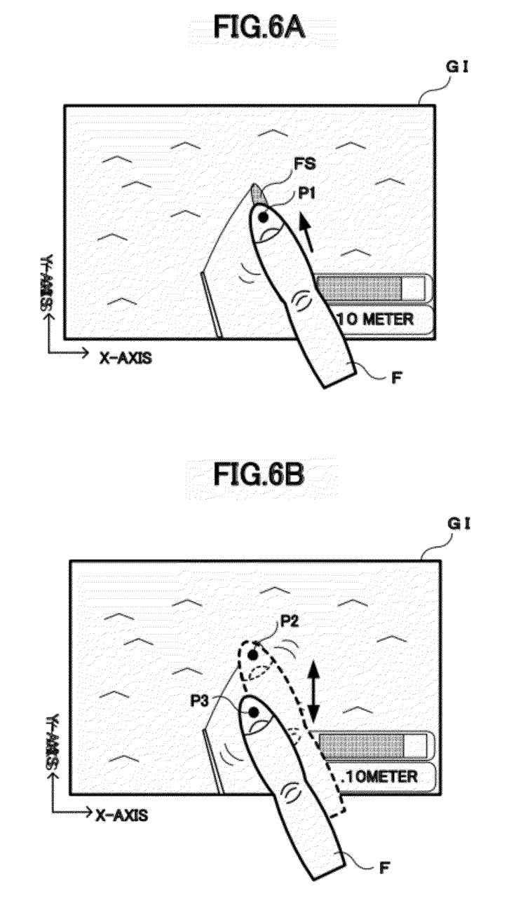

More specifically, the detection part 150 detects the follow operation in which the player moves his/her finger F to follow the move of the fish shadow FS on the game image GI (more specifically, on the touch panel 20) as shown in FIG. 6A. In other words, the detection part 150 detects the follow operation when the successively detected positions of a contact point P1 match the positions (areas) of the moving fish shadow FS.

Furthermore, the detection part 150 detects operation on the virtual reel and virtual fishing rod.

For example, when the player repeatedly moves his/her finger F in the vertical direction (the direction Y in the figure) on the game image GI as shown in FIG. 6B, the detection part 150 detects a virtual reel-in operation. In other words, the detection part 150 is able to detect a virtual reel-in operation when the successively detected positions of contact points P2 and P3 are arranged in the vertical direction. In addition, the detection part 150 detects a virtual reel-out operation (the operation to release the reel and extend the fishing line) when the finger F on the touch panel 20 is stopped. Furthermore, when the finger F on the touch panel 20 moves right and left, the detection part 150 detects the operation to change the orientation of the virtual fishing rod.

The above-described CPU core 10a and touch panel controller 10g can function as the above detection part 150.

Returning to FIG. 3, the calculation part 160 calculates a catching area based on the position of the fish object (fish shadow) on the hook and the like under the control of the control part 140. The catching area is an area of a given shape that moves along with the fish object on the hook, defining a range the player should touch with a finger or the like to follow the move of the fish object. For example, the calculation part 160 successively calculates a catching area changing in shape and/or size according to the physical strength of the fish object on the hook.

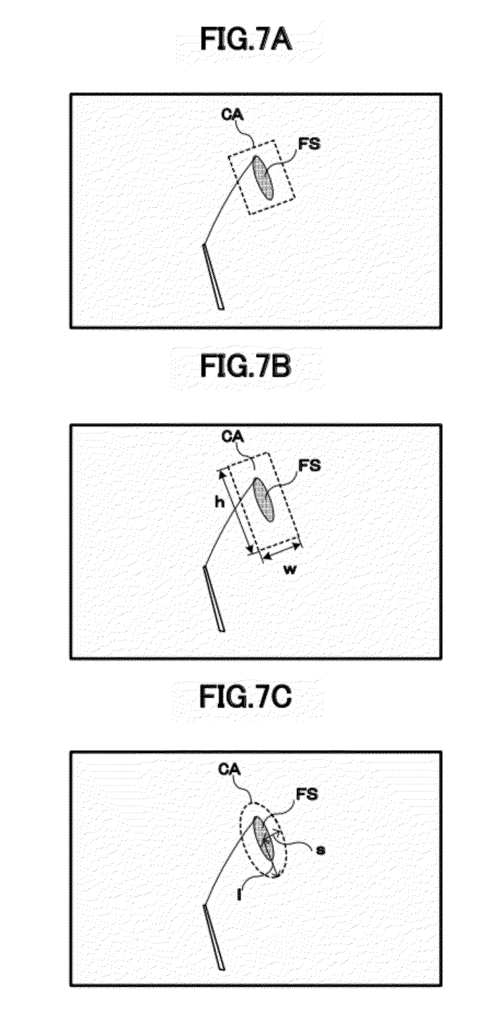

More specifically, the calculation part 160 calculates a rectangular catching area CA surrounding the fish shadow FS as shown in FIG. 7A. In other words, the catching area CA moves along with the fish shadow FS. The player is required to move the finger or the like on the touch panel 20 so as to keep touching the catching area CA. The catching area CA is calculated but not displayed; it is invisible to the player.

The calculation part 160 changes the catching area in size and shape according to the physical strength of the fish object on the hook. For example, provided that the catching area CA is rectangular, the calculation part 160 calculates and changes the vertical length (height) and horizontal length (width) thereof according to the physical strength of the fish object. More specifically, the width of the catching area CA is set in proportion to the physical strength and the height of the catching area CA is set in inverse proportion to the physical strength. In other words, the calculation part 160 changes the catching area CA in the manner that the width is decreased and the height is increased as shown in FIG. 7B as the physical strength diminishes. Such a change in the catching area CA is given by way of example. The catching area CA can be changed in other manners as appropriate. Alternatively, no change is acceptable.

Furthermore, the catching area CA is not limited to a rectangular shape as described above and can have other shapes. For example, an oval catching area CA as shown in FIG. 7C can be used. Also in such a case, the large axis 1 and small axis s are changed according to the physical strength of the fish object.

The above-described CPU core 10a and WRAM 10e can function as the above calculation part 160.

Returning to FIG. 3, the modification part 170 increases/decreases the physical strength of the fish object on the hook based on the positional relationship between the catching area calculated by the calculation part 160 and the position of the player's finger or the like (the contact position) detected by the detection part 150.

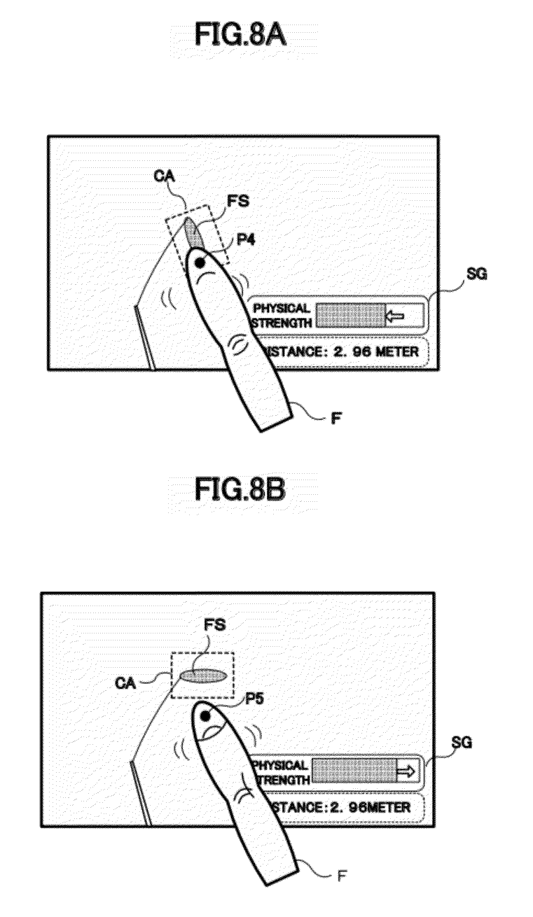

For example, as shown in FIG. 8A, when the contact position P4 of the player's finger F is within the catching area CA (when the finger F keeps up with the catching area CA moving along with the fish shadow FS), the modification part 170 accesses the supervising part 110 and decreases the physical strength of the fish object on the hook by a given quantity in a given unit time. In other words, the physical strength gauge SG in the figure is decreased.

On the other hand, as shown in FIG. 8B, when the contact position P5 of the player's finger F is outside the catching area CA (when the finger F fails to keep up with the catching area CA moving along with the fish shadow FS), the modification part 170 accesses the supervising part 110 and increases the physical strength of the fish object on the hook (restores the physical strength). In other words, the physical strength gauge SG in the figure is increased. Here, the physical strength may be increased by up to the quantity decreased and may not be increased beyond the initial value.

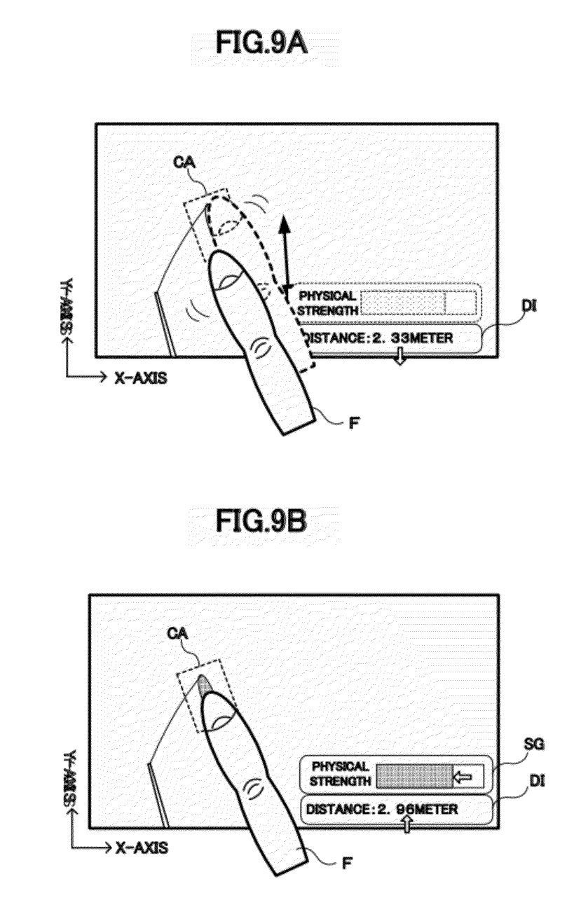

The modification part 170 increases/decreases the distance to the fish object on the hook based on a specific operation detected by the detection part 140. For example, as shown in FIG. 9A, when the finger F on the touch panel F is repeatedly moved in the vertical direction (the direction Y in the figure) (when the contact position reciprocates vertically), the detection part 150 detects a virtual reel-in operation and the modification part 170 decreases the distance to the fish object, for example, by a given quantity according to the number of strokes. In other words, the distance indicator DI in the figure is decreased.

On the other hand, as shown in FIG. 9B, when the finger F on the touch panel 20 is stopped (the contact position is almost unchanged), the detection part 150 detects a virtual reel-out operation and the modification part 170 increases the distance to the fish object, for example, by a given quantity in a given unit time. In other words, the distance indicator DI in the figure is increased. Meanwhile, the physical strength of the fish object is decreased.

In addition, when the finger F on the touch panel 20 is moved in the horizontal direction (the direction X), the detection part 150 detects an operation to change the orientation of the fishing rod and the modification part 170 changes information on the orientation of the fishing rod.

The above-described CPU core 10a and WRAM 10e can function as the above modification part 170.

The determination part 180 determines whether the fish object on the hook is caught based on the physical strength and distance supervised by the supervising part 110.

For example, when both the physical strength and distance of the fish object on the hook are equal to or lower than reference values, the determination part 180 determines that the fish object is exhausted to a certain degree, is pulled in close to the player, and caught (recovered with a net). On the other hand, when the fish object on the hook is not caught within a given time limit (for example, five minutes), the determination part 180 determines that the fish has escaped.

In addition, the determination part 180 determines that the fish object has escaped when the player's finger F has been outside the catching area CA for a specific time period (for example, the accumulated time) or when the virtual reel-in operation is conducted before the fish object on the hook has become sufficiently immobile.

The above-described CPU core 10a and WRAM 10e can function as the above determination part 180.

Here, the above embodiment employs a touch panel as the detection part to detect the indication operation of the player. However, the present invention is not restricted to the detection part using a touch panel.

For example, a mouse can be used for input of indication operation. For example, it is possible to identify the operation position from the position of a pointer on the screen specified by a mouse and detect input of indication operation while the pointer is moved on the screen with the right button pressed.

Alternatively, in a game device capable of detecting infrared light from an input device such as a controller held by the player for playing, it is possible to detect infrared light to identify the operation position and detect input of indication operation while a button on the input device is pressed.

Furthermore, in a game device capable of analyzing image data presenting an image captured by a camera and identifying a part of the player (a hand, foot, face, etc. of the player) in the image for input of indication operation, it is possible to analyze and identify the position of the user in a captured image and let the user make a specific move to detect input of indication operation.

Outline of the Operation of the Game Device

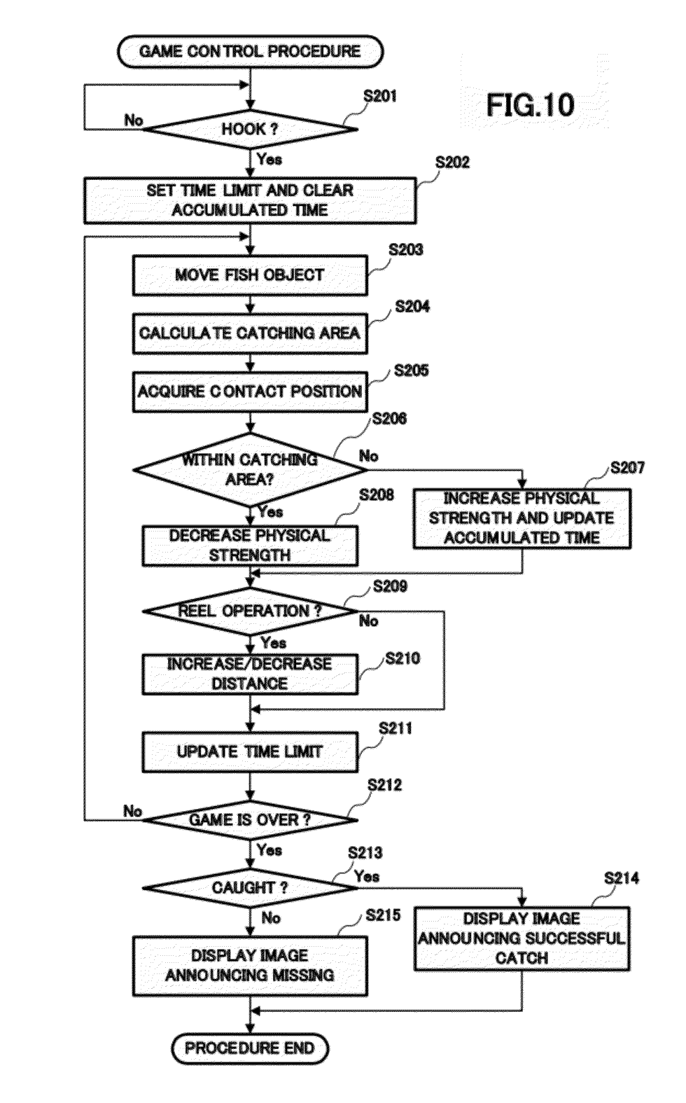

Operation of the game device 100 having the above configuration will be described hereafter with reference to the drawings. Operation of the game device 100 executing a fishing game will be described with reference to FIG. 10 by way of example. FIG. 10 is a flowchart showing the flow of a game control procedure. This game control procedure starts, for example, after the player selects any bait (lure type) as appropriate and throws (casts) the bait at a desired point.

First, the game device 100 determines whether a fish object is on the hook (Step S201).

In other words, the control part 140 determines whether the player has executed the operation to move the fishing rod in a timely manner with respect to signs of a bite (trembling of the fishing rod, etc.). For example, if the player is supposed to tap the touch panel 20 at the position of the tip of the fishing rod displayed to slightly raise the fishing rod, the control part 150 determines whether the player has tapped in a timely manner based on information obtained from the detection part 140.

If there is no fish on the hook (Step S201; No), the game device repeats the determination whether there is a fish on the hook.

On the other hand, if there is a fish on the hook (Step S201; Yes), the game device 100 sets a time limit and clears the accumulated time (Step S202).

In other words, the control part 140 sets a time limit (for example, five minutes) for catching the fish object on the hook and clears the accumulated time during which the player fails to follow. These times are updated as appropriate, which will be described later.

The game device 100 moves the fish object on the hook (Step S203).

In other words, the control part 140 updates the position and orientation supervised by the supervising part 110 as appropriate to move the fish object on the hook. More specifically, the control part 140 changes the orientation (swimming direction) of the fish object randomly in each given elapsed time and moves the fish object on the hook at a speed according to the current physical strength of the fish object. The control part 140 also lets the fish object on the hook rest for a given time period each time the physical strength of the fish object is decreased by a given quantity.

In accordance with the above control on the move of the fish object, the image generation part 120 generates game images GI in which the fish shadow FS irregularly migrates such as the above-described FIG. 5 and displays the game images GI on the display part 130.

The game device 100 calculates a catching area (Step S204).

In other words, the calculation part 160 successively calculates a catching area changing in shape and/or size according to the physical length and the like of the fish object on the hook. More specifically, the calculation part 160 calculates a catching area CA surrounding the fish shadow FS as shown in the above-described FIG. 7A. Here, the catching area CA is calculated but not displayed; it is invisible to the player.

The game device 100 acquires the contact position (Step S205).

In other words, the detection part 140 detects the contact position of the player's finger or the like based on information obtained from the touch panel 20.

The game device 100 determines whether the contact position is within the catching area (Step S206).

In other words, the modification part 170 determines whether the detected contact position is within the catching area calculated in the Step 5204.

For example, it is determined whether the contact position P4 of the player's finger F is within the catching area CA as shown in the above-described FIG. 8A or the contact position P5 of the player's finger F is outside the catching area CA as shown in the above-described FIG. 8B. If no contact position is obtained in the above-described Step S205 (in other words, the player's finger or the like is not touching the touch panel 20), it is assumed to be outside the catching area CA.

If the contact position is not within the catching area (Step S206; No), the game device 100 increases the physical strength and updates the accumulated time (Step S207).

In other words, the modification part 170 accesses the supervising part 110 and increases the physical strength of the fish object on the hook by a given quantity. Furthermore, the modification part 170 updates (increases) the accumulated time by an amount of time during which the contact position is outside the catching area.

On the other side, if the contact position is within the catching area (Step S206; Yes), the game device 100 decreases the physical strength (Step S208).

In other words, the modification part 170 accesses the supervising part 110 and decreases the physical strength of the fish object on the hook by a given quantity.

After the Step S207 or S208, the game device 100 determines whether there is any reel operation (Step S209).

In other words, the detection part 140 determines whether there is a virtual reel-in operation (the contact position reciprocates in the vertical direction) or virtual reel-out operation (the contact position remains the same) based on the successively detected contact position.

If there is no reel operation (Step S209; No), the game device 100 proceeds to Step S211, which will be described later.

On the other hand, if there is any reel operation (Step S209; Yes), the game device 100 increases/decreases the distance (Step S210).

In other words, the modification part 170 accesses the supervising part 110 and decreases the distance to the fish object on the hook, for example, by a given quantity according to the number of times the finger or the like reciprocates in the vertical direction when the virtual reel-in operation is conducted. On the other hand, the modification part 170 increases the distance to the fish object, for example, by a given quantity in a given unit time when the virtual reel-out operation is conducted.

After the Step S209; No or Step S210, the game device 100 updates the time limit (Step S211).

In other words, the control part 140 updates (decreases) the time limit by the elapsed time.

The game device 100 determines whether the game is over (Step S212).

In other words, the determination part 180 determines whether any game ending condition is satisfied based on information supervised by the supervising part 110. More specifically, the determination part 180 determines that an ending condition is satisfied when both the physical strength and distance of the fish object on the hook are equal to or lower than reference values (the fish object is caught), the time limit is equal to zero (the time is up), the accumulated time exceeds a given value, or the virtual reel-in operation is conducted before the fish object on the hook becomes sufficiently immobile (the fishing line is broken).

If the game is not over (Step S212; No), the game device 100 returns to the Step S203 and repeats the processing in the above-described Steps S203 to Step S212.

On the other hand, if the game is over (Step S212; Yes), the game device 100 determines whether the catch was successful (Step S213).

In other words, it is determined whether the ending condition “both the physical strength and distance are equal to or lower than reference values” is satisfied in the above-described Step S212.

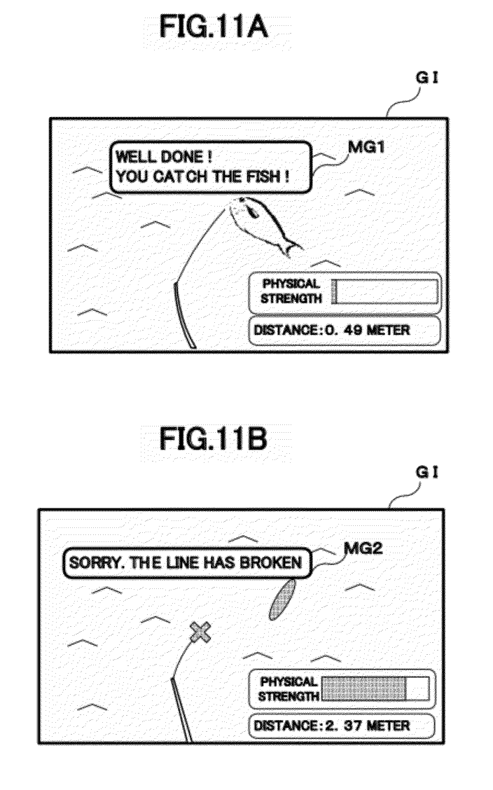

If the catch was successful (Step S213; Yes), the game device 100 displays an image announcing the catch of the fish object (Step S214). For example, the image generation part 120 generates a game image GI including a message image MG1 as shown in FIG. 11A and displays the game image GI on the display part 130. Then, the game device 100 ends the game control procedure.

On the other hand, if the catch was unsuccessful (Step S213; No), the game device 100 displays an image announcing the missing of the fish object (Step S215). For example, when the ending condition “the virtual reel-in operation is conducted before the fish object becomes sufficiently immobile” is satisfied in the Step S212, the image generation part 120 generates a game image GI including a message image MG2 as shown in FIG. 11B and displays the game image GI on the display part 130. Then, the game device 100 ends the game control procedure.

The game control procedure as described above allows the player to get the thrill of pulling in a fish while making it exhausted in actual fishing through the follow operation to follow the move of a fish object on the hook (a fish shadow) with a finger or the like.

In this way, the player can get the feeling of interaction with a fish on the hook through easier operation.

Consequently, the player can get the feeling of interaction in catching a virtual object through easier operation.

### Other Embodiments

In the above embodiment, how to catch a fish in a fishing game is explained by way of example. A virtual object to catch is not limited to a fish object and can be any object.

For example, a game of dragging in a specific character (a monster object, etc) by a rope is applicable as appropriate.

In the above embodiment, the game device or a terminal comprises the control, display, calculation, detection and modification parts. However, the present invention is not confined to such an embodiment.

The control, display, calculation, detection and modification parts may be provided on an external server device. For example, using a cloud system, the configuration of the present invention is provided on an external server device so as to reduce the workload on the terminal and improve the security.

Alternatively, multiple external server devices are prepared and the processing is distributed among the multiple server devices according to the contents of processing.

The components of the present invention can be provided to the server device or to the terminal on an arbitrary basis. Then, the signal flows among components in the block diagram of FIG. 3 may be changed as appropriate depending on whether the components are provided to the server device or to the terminal.

Typically, it is possible to provide the control, calculation, and modification parts to the server device and the display and detection parts to the terminal

In such a case, the control part on the server device controls the move of an object and sends signals regarding the move to the display part on the terminal. The display part displays an object on the screen based on the received signals.

Furthermore, the detection part on the terminal sends to the modification part on the server device signals regarding the position of touch operation detected on the touch panel each time touch operation is detected.

The modification part increases/degreases the parameter of an object based on the positional relationship between the received position of touch operation and the catching area calculated by the calculation part on the server device.

As described above, the present invention can provide a game device, game control method, and a non-transitory computer-readable information recording medium storing a program for giving the feeling of interaction in catching a virtual object through easier operation.

Having described and illustrated the principles of this application by reference to preferred embodiments, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

What is claimed is:

1. A game device of catching a virtual object, comprising:
a controller moving the object in a virtual space;
a display displaying a position of the moving object on a screen;
a calculator calculating a catching area defined based on the position of the displayed object and, the catching area being changed in shape and/or size according to a parameter of the object;
a detector detecting indication operation indicating a position on the screen; and
a modifier increasing/decreasing the parameter of the object based on the positional relationship between the position of the indication operation and the calculated catching area while the indication operation is detected.

2. The game device according to claim 1, wherein:
the detector detects touch operation of a player via a touch panel superimposed on the screen.

3. The game device according to claim 2, further comprising:
a supervisor supervising a parameter of the object for which at least a different initial value is set according to the type of the object,
wherein the modifier controls the supervisor to decrease the parameter when the position of the detected touch operation is within the catching area, and controls the supervisor to increase the parameter when the position of the detected touch operation is outside the catching area.

4. The game device according to claim 3, wherein:
the supervisor further supervises the virtual distance between the object and the player; and
the modifier controls the supervisor to increase/decrease the distance based on the direction of successive moves when the position of touch operation detected by the detector is successively moved.

5. The game device according to claim 4, comprising:
a determiner determining whether the object is caught based on the parameter and the distance supervised by the supervisor.

6. A server device providing a game of catching a virtual object to a player using a communicably connected terminal, comprising:
a controller moving the object in a virtual space;
a display displaying a position of the moving object on the screen of the terminal;
a calculator calculating a catching area defined based on the position of the displayed object and, catching area begin changed in shape and/or size according to a parameter of the object;
a detector detecting indication operation indicating a position on the screen; and
a modifier increasing/decreasing the parameter of the object based on the positional relationship between the position of the indication operation and the calculated catching area while the indication operation is detected.

7. A game system providing a game of catching a virtual object to a player using a terminal communicably connected to a server device, realizing the following at least either on the server device or on the terminal:
a controller moving the object in a virtual space;
a display displaying a position of the moving object on the screen of the terminal;
a calculator calculating a catching area defined based on the position of the displayed object and, the catching area being changed in shape and/or size according to a parameter of the object;
a detector detecting indication operation indicating a position on the screen; and
a modifier increasing/decreasing the parameter of the object based on the positional relationship between the position of the indication operation and the calculated catching area while the indication operation is detected.

8. A game control method for a game device of catching a virtual object comprising a display, calculator, detector, and modifier, comprising:
a control step in which the controller moves the object in a virtual space;
a display step in which the display displays a position of the moving object on a screen;
a calculation step in which the calculator calculates a catching area defined based on the position of the displayed object and, the catching area being changed in shape and/or size according to a parameter of the object;
a detection step in which the detector detects indication operation indicating a position on the screen; and
a modification step in which the modifier increases/decreases the parameter of the object based on the positional relationship between the position of the indication operation and the calculated catching area while the indication operation is detected.

9. A programs-recorded computer-readable non-temporary information recording medium allowing a computer of catching a virtual object to function as:
a controller moving the object in a virtual space;
a display displaying a position of the moving object on a screen;
a calculator calculating a catching area defined based on the position of the displayed object and, the catching area being changed in shape and/or size according to a parameter of the object;
a detector detecting indication operation indicating a position on the screen; and
a modifier increasing/decreasing the parameter of the object based on the positional relationship between the position of the indication operation and the calculated catching area while the indication operation is detected.
